(19) United States
(12) Patent Application Publication
(10) Pub. No.: US 2026/0220262 A1
(43) Pub. Date: Jul. 30, 2026

(54) EMAIL THREAT DETECTION USING RETRIEVAL-AUGMENTED GENERATION AND LARGE LANGUAGE MODELS

(71) Applicant: Cisco Technology, Inc., San Jose, CA (US)

(72) Inventors: Jan Brabec, Praha (CZ); Florian Becker, Prague (CZ); Radek Starosta, Praha (CZ); Tomas Sixta, Praha (CZ); Filip Srajer, Hradec Kralove (CZ)

(21) Appl. No.: 19/177,305

(22) Filed: Apr. 11, 2025

Related U.S. Application Data
(60) Provisional application No. 63/749,226, filed on Jan. 24, 2025.

(51) Int. Cl. G06F 21/55

(52) U.S. Cl. CPC G06F 21/554; G06F 2221/034

(57) ABSTRACT

This disclosure describes techniques for prioritized email security to assist with threat detection related to communications across a network. The techniques include analyzing multiple email communications for potentially malicious content. The techniques may also include determining a priority score for an individual email of the multiple email communications. The priority score may be compared to a predetermined threshold priority value. Based at least in part on the priority score, the individual email may be designated as a prioritized email. The techniques may include using metadata of the prioritized email to identify similar emails from a vector database. Information from the similar emails may be used to assist in classifying the prioritized email with a large language model (LLM) classifier, generating a classification label for the prioritized email. As such, password linkage techniques may improve security in network communications.

### RELATED APPLICATIONS

This Application claims priority to U.S. Provisional Patent Application No. 63/749,226, filed January 24, 2025, which is incorporated herein by reference.

### TECHNICAL FIELD

The present disclosure relates generally to threat detection in network communications, thereby improving security of a network against potential threats.

### BACKGROUND

In network environments, users may communicate information across the network. The information may originate from a computing device outside a secure network, system, or organization. For instance, a user within an organization may receive a communication, such as an email, from an outside contact or entity. A security system of the organization may be tasked with determining whether the communication poses a threat to the organization. The growing sophistication of Business Email Compromise (BEC) and spear phishing attacks poses significant challenges to organizations worldwide, as it becomes more difficult for security systems to differentiate regular communications from security risks. Techniques featured in traditional spam and phishing detection may be insufficient due to the tailored nature of modern BEC attacks, which are designed to blend in with the regular benign email traffic. The difficulty of detecting security risks can lead to inefficiency in communications, lost emails, or consuming administrative resources to analyze problematic communications.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. In some cases, parentheticals are utilized after a reference number to distinguish like elements. Use of the reference number without the associated parenthetical is generic to the element. The systems depicted in the accompanying figures are not to scale and components within the figures may be depicted not to scale with each other.

FIGS. 1A and 1B illustrate component diagrams with example environments in which prioritized email security concepts may be employed as part of communications between network devices, in accordance with the present concepts.

FIGS. 2 illustrates an example algorithm for the use of prioritized email security concepts as a part of communications among network devices, in accordance with the present concepts.

FIGS. 3 and 4 illustrate flow diagrams of example methods for the use of prioritized email security concepts as a part of communications among network devices, in accordance with the present concepts.

FIG. 5 illustrates a computing system diagram illustrating a configuration for a data center that can be utilized to implement aspects of the technologies disclosed herein.

FIG. 6 is a computer architecture diagram showing an illustrative computer hardware architecture for implementing a computing device that can be utilized to implement aspects of the various technologies presented herein.

### DESCRIPTION OF EXAMPLE EMBODIMENTS

### OVERVIEW

This disclosure describes, at least in part, a method that may be implemented by a security system in a networked computing environment that is communicatively coupled to one or more external devices and/or other computing devices. The method may include receiving multiple email communications from one or more external devices. The method may include analyzing the multiple email communications for potentially malicious content. In some examples, analyzing the multiple email communications may include determining a priority score for an individual email of the multiple email communications. The priority score may indicate a confidence level of the individual email being malicious. The priority score may be compared to a predetermined threshold priority value, in some examples. Based at least in part on the priority score being higher than the predetermined threshold priority value, the individual email may be designated as a prioritized email, for instance. The method may further include accessing metadata of the prioritized email. The metadata may be used to identify one or more emails from a vector database that are similar to the prioritized email. The method may continue with classifying the prioritized email with a large language model (LLM) classifier. The LLM classifier may use information from the similar emails from the vector database in the classification process. The method may include generating a classification label for the prioritized email. Further, the method may include forwarding the prioritized email with the classification label to an intended recipient.

This disclosure also describes, at least in part, another method that may be implemented by a security system in a networked computing environment that is communicatively coupled to one or more external devices and/or other computing devices. The method may include receiving multiple email communications from one or more external devices. The method may include determining priority scores for individual emails of the multiple email communications. In some examples, the priority scores may indicate a confidence level that any given individual email may be a malicious email. The method may include performing a comparison of the priority scores to a predetermined threshold priority value. The method may further include selecting prioritized emails of the multiple email communications based at least in part on the comparison. Finally, the method may include classifying the prioritized emails with a large language model (LLM) classifier to generate classification labels for the prioritized emails. In some examples, the method may include determining whether to forward the prioritized emails to respective intended recipients based as least in part on the classification labels.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for detecting suspicious communications and determining whether to classify a communication as a security risk. For example, a security system may use a generative large language model (LLM) to analyze incoming communications (e.g., emails). However, using complex computing techniques to analyze every communication could be prohibitively resource consumptive and likely delay communications. For this reason, the techniques for detecting suspicious communications include prioritization to reduce computational cost. Therefore, prioritized email security techniques can help improve the overall efficiency of the security system.

Recent advances in artificial intelligence (AI), specifically with generative LLMs, have very promising application potential in the email security domain. Even though email is a complex multi-modal format, the main modality is human-readable text, a format at which the LLMs excel. Stated another way, email data is relatively well-understood by LLMs. However, analyzing an email in isolation may not be sufficient in practice for a well-performing email security system. The communication context also needs to be considered. The disclosed techniques describe a performant and cost-efficient system that employs an LLM in email security to convict suspicious messages. The system also provides the LLM with the necessary contextual information, such as information about similar emails that were observed in the telemetry, and potentially their verdicts, if available. For instance, a Retrieval-Augmented Generation (RAG) technique may be used to enhance the quality of the results from the LLM. In some examples, the RAG component may access a database of example emails in order to provide contextual information to the LLM.

Furthermore, due to the computational costs associated with processing potentially extremely large volumes of emails with LLMs, especially when augmented by additional techniques such as context consideration, it becomes advantageous for the system to select a subset of emails that will be analyzed by the LLM. Therefore, the disclosed techniques include prioritization techniques to enhance email security. In some examples, the prioritization techniques may provide a score that represents confidence in an email being malicious. A threshold on the score may be used to significantly reduce the number of emails analyzed by LLM. For instance, application of the threshold may result in approximately 1 in every 5000 emails being selected for LLM analysis. Such prioritization can help make the system cost-efficient with respect to both computational resources and time. Prioritization can also improve the subsequent result from the LLM, since prioritization may simplify the task for the LLM. The task of the LLM may be simplified because the original data stream may be extremely class-imbalanced. Stated another way, out of an original stream of incoming emails, very few may actually be malicious, even less than 0.1% malicious in some examples. After prioritization, a prioritized data stream may be relatively more balanced. For instance, the probability of any given email being malicious after prioritization may be approximately 50%. With a more balanced input stream, the LLM may provide an overall higher percentage of correctly classified malicious emails than if the LLM simply worked on all incoming emails.

To summarize, a more efficient and more successful technique is presented for protecting organizations from potentially harmful communications, including malicious emails. In some examples, LLM assisted by RAG may be run on a prioritized subset of incoming emails. The disclosed techniques can classify emails in real-time into various categories indicating whether the email is suspicious. The result of running the LLM with RAG on a prioritized subset of emails can result in an overall higher percentage of correctly classified malicious emails than by using any of the techniques in isolation.

Although the examples described herein may refer to a security system and/or email classification service which may be offered via computing resources in a data center, the techniques can generally be applied to any device in a network. For instance, the prioritized email security concepts are expected to work within any of a variety of email applications, communications systems, messaging systems, etc. Further, the techniques are generally applicable for any network of devices managed by any entity where data traffic is sent over a network, virtual resources are provisioned, and/or remote services are accessed. In some instances, the techniques may be performed by software-defined networking (SDN), and in other examples, various devices may be used in a system to perform the techniques described herein. The devices by which the techniques are performed herein are a matter of implementation, and the techniques described are not limited to any specific architecture or implementation.

The techniques described herein provide various improvements and efficiencies with respect to network communications. For instance, the techniques described herein may increase the security of data and/or reduce the amount of computational resource use, storage, dropped data, latency, and other issues experienced in networks due to lack of network resources, overuse of network resources, issues with timing of network communications, and/or improper routing of data. By improving network communications across a network, overall performance by and/or security related to servers and virtual resources may be improved.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

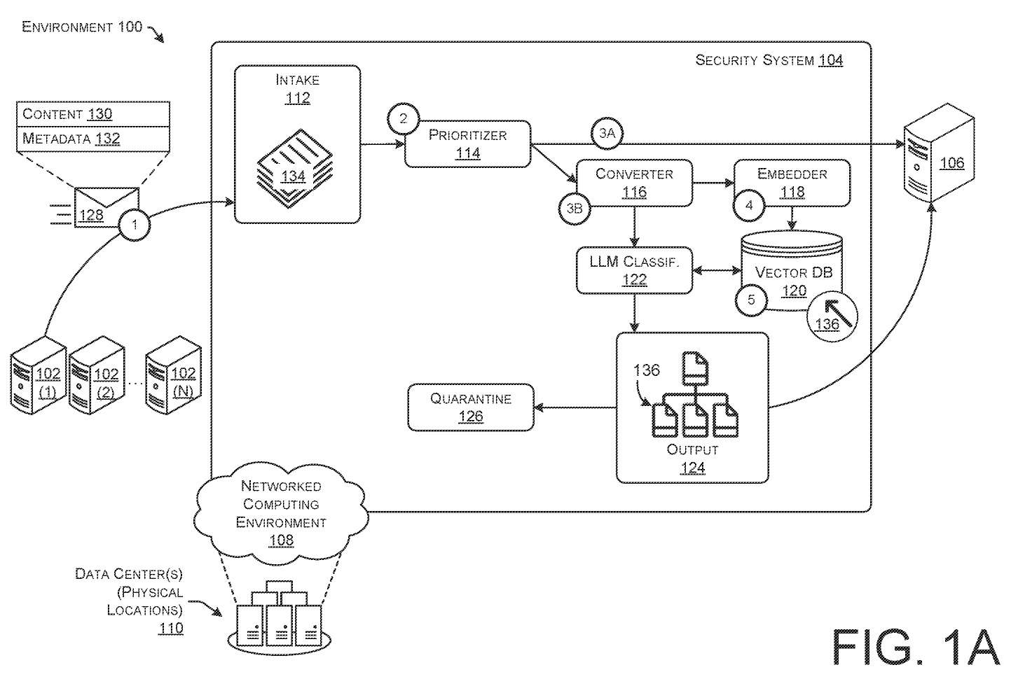

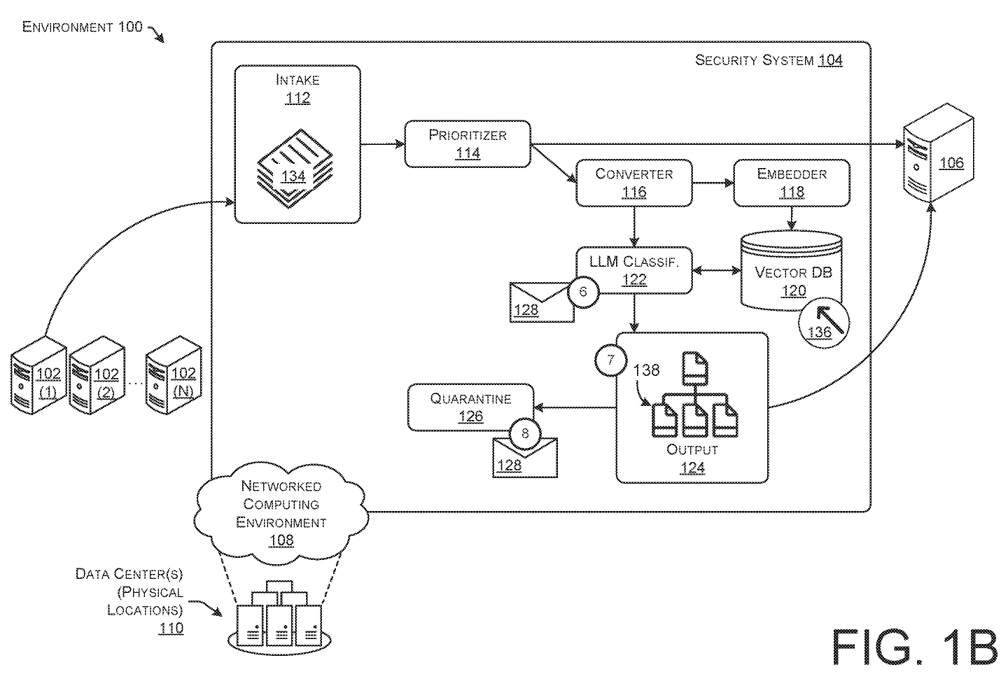

FIGS. 1A and 1B collectively illustrate an example environment 100 in accordance with prioritized email security concepts. As shown in FIGS. 1A and 1B, environment 100 may include one or more user devices 102, a security system 104, and a computing device 106. In some cases, parentheticals are utilized after a reference number to distinguish like elements. Use of the reference number without the associated parenthetical is generic to the element. For instance, three user devices 102 are shown, including user device 102(1), user device 102(2), and user device 102(N), where “N” refers to any integer, indicating any number of potential user devices 102. The number of elements depicted in FIGS. 1A and 1B, such as user devices 102, the services and/or devices representing security system 104, and computing device 106 is not meant to be limiting; any number of elements are contemplated in accordance with the present password linkage concepts. For instance, user device 102 may represent any number of external devices that may send communications to security system 104 and or the networked computing environment 108. Similarly, computing device 106 may represent any number of intended recipients of the communication(s) arriving at security system 104.

The security system 104 may be viewed as a collection of services (e.g., applications, microservices, storage, database) that are provided via a networked computing environment 108, which may be manifested as one or more data centers 110 (e.g., physical locations). In some examples, the services/functions provided by the security system 104 may include intake 112, prioritizer 114, converter 116, embedder 118, vector database 120, LLM classifier 122, output 124, and quarantine 126, for instance. The services of security system 104 will be described in greater detail through the example(s) provided below. The security system 104 may be associated with an organization, application, or other entity. In some examples, the security system 104 may operate as a cloud-based service. In other examples, the security system 104 may be provided via an on-premise network of one or more devices. The security system 104 may be in place at least in part to protect the organization or other entity from potential threats that may arrive in communications, such as email messages.

Any of the devices and/or services of environment 100 may be communicatively coupled to various other devices of environment 100 via network connection(s). For instance, networked computing environment 108 may represent a cloud network, which may feature a variety of devices (e.g., routers, servers, computing devices, controller devices, controllers) and other network devices. Within the example environment 100, any of the devices (e.g., user device 102, the devices of data center(s) 110, computing device 106, etc.) may exchange communications (e.g., packets) via network connection(s). For instance, the network connections may be transport control protocol (TCP) network connections or any network connection (e.g., information-centric networking (ICN)) that enable the network devices to exchange packets with other devices via the network connections. The network connections represent, for example, data paths between the devices of environment 100. It should be appreciated that the term “network connection” may also be referred to as a “network path.” The use of a cloud computing network in this example is not meant to be limiting. Other types of networks are contemplated in accordance with password linkage concepts, such as an enterprise system. In some examples, the security system 104 and/or computing device 106 may be considered part of a local area network, or a software defined wide area network (SD-WAN). A variety of architectures are envisioned for the manifestation of elements of security system 104. For instance, in some examples, prioritizer 114, vector database 120, and/or LLM classifier 122 may be manifest as an application or microservice running on one or more computing devices within the organization or within the same data center 110. In other examples, an element of security system 104 may run as a separate cloud-based service, relatively independent from other physical devices of security system 104.

In general, example environment 100 may be used to illustrate a scenario in which an email 128 (e.g., communication, email communication, message) is received at the security system 104. The email 128 may have been sent from user device 102(1). The email 128 may be intended for delivery to a user and/or organization. The sending user device 102(1) may be external to the organization, such that the user device 102(1) may be referred to as an external device. In the example shown in FIG. 1A, the email 128 may include a variety of features, such as content 130 (e.g., email body, text, images, attachments) and/or metadata 132. Further, in some examples, email 128 may generally be viewed as data traffic 134 that may include multiple emails and/or other communications arriving at intake 112 of security system 104 from one or more of the user devices 102.

The scenario depicted in environment 100 may include examples of communications between various devices and/or services offered by elements of environment 100. In FIGS. 1A and 1B the communications are indicated with circled numbers. For example, referring to FIG. 1A, at “Step 1,” user device 102 may send email 128 to intake 112. Thus, the email 128 from the external device has arrived at a service (e.g., intake 112) of security system 104.

At “Step 2” of FIG. 1A, after receiving email 128, intake 112 may route the email 128 to prioritizer 114. In some examples, routing any email to the prioritizer 114 may be a routine process for incoming email to the organization. In other examples, routing the email 128 to the prioritizer 114 may be triggered by recognizing that the email 128 in question may contain potentially malicious material, such as a link or attachment. Due to the computational costs associated with processing potentially extremely large volumes of emails with LLMs, the prioritizer 114 may first select only a subset of email data traffic 134 that will be analyzed by the LLM. In some examples, prioritizer 114 may analyze email 128 and provide a priority score that represents a confidence level in email 128 being malicious. The score may be based on analysis of content 130, metadata 132, and/or a variety of other factors influencing the likelihood that email 128 is malicious. Prioritizer 114 may also apply a threshold on the priority score. For purposes of illustration, in an instance where data traffic 134 contains 5000 emails received over a certain time period, email 128 may represent only one email out of the 5000 emails to feature a priority score that exceeds the threshold. Therefore, out of the 5000 emails of data traffic 134, only email 128 may be selected for the LLM analysis for that certain time period. As more time periods pass and the data traffic 134 continues to be prioritized for further processing, the reduction in volume of emails that are run through the LLM classifier 122 may be enormous. Therefore, in general, prioritization can make the security system 104 much more cost-efficient and can also simplify the task for the LLM. As suggested above, the original data traffic 134 may be extremely class-imbalanced, while the prioritized data stream is more balanced. For instance, in the prioritized data stream the probability of a selected email being malicious may rise to approximately 50%, or between 40-60%. In contrast, the probability of an email in the original, non-prioritized data stream being malicious may be very low, such as less than 0.1%.

At “Step 3A” of FIG. 1A, emails in data traffic 134 that have priority scores that do not pass the threshold value for further scrutiny assigned by prioritizer 114 may pass on toward the intended recipient, represented here as computing device 106. As noted above, computing device 106 may represent any number of intended recipients of the communication(s) arriving at security system 104.

At “Step 3B” of FIG. 1A, emails in data traffic 134 that have priority scores that do pass the threshold value for further scrutiny assigned by prioritizer 114, such as email 128, may proceed to converter 116 (e.g., text representation converter). Communications, such as email 128, may originally be represented in Multipurpose Internet Mail Extensions (MIME) or another email or communications format. Email 128 may need to be converted to a simpler string to facilitate analysis of the email content. For example, a MIME file may contain unnecessary information and/or the content 130 of email 128 may be encoded, such as in base64, and thus may be not directly visible. The converter 116 may create a simplified representation of the email 128. In some examples, the simplified representation may contain selected header fields (e.g., from, sender, to, cc, subject, etc.) and/or an Authentication-Results String representation of the content 130 (e.g., the email body). The email body is often formatted in html, in such a case the tags may be stripped and the email body may be converted to a markdown-like representation of the content 130. The simplified representation may also contain URLs, attachment filenames, and/or representations of various aspects of metadata 132.

At “Step 4” of FIG. 1A, a text representation of email 128 may proceed to embedder 118. Embedder 118 may embed, or convert the text representation of email 128 to vector 136, a vector representation of email 128 (e.g., email 128 represented by one or more vectors). Vector 136 is intended to retain the semantics of the message from email 128. Embedding of similar messages are expected to result in vectors with high cosine similarity and vice-versa. Various embedder models are contemplated for this task.

At “Step 5” of FIG. 1A, the vector 136 representing email 128 may be sent to vector database 120. Vector 136 representing email 128 may be stored in vector database 120 along with vector representations of other communications. The storage of vector 136 in vector database 120 may allow quick identification and retrieval of communications based on vector similarity to email 128. Thus, communications similar to email 128 may be efficiently located and retrieved from vector database 120, via the associated vector representations, where a similarity is identified to the content 130 and/or metadata 132 of email 128. The values of vector 136 may correspond to various aspects of email 128, such as a header, subject, attachment filename, or URL. The information stored with vector 136 may also include additional information from other sources, such as an email label that comes from threat a intelligence source, user feedback regarding an email or label, previous system verdicts, etc. In some examples, the vector database 120 can be a standalone database; in other examples, the vector database 120 can be an in-memory data structure that supports vector search. The form of the vector database 120 may be dependent on size (or required resources), for instance.

At “Step 6” of FIG. 1B, LLM classifier 122 may consider email 128 in a classification process. Note that in some examples, email 128 may proceed to LLM classifier 122 from converter 116 without having passed to the embedder 118. Routing of emails through the various elements of the security system 104 will be described in more detail below.

In some examples, LLM classifier 122 may be a generative LLM model. The generative LLM model may be provided with a prompt that includes one or more descriptions related to the classification task. For examples, the prompt may include a description of the classification task and/or the desired output categories. The prompt may include a description of the output format. In some instances, the output may consist of a limited amount of information, such as only the category name, to reduce latency of the model as it scales with the output size. The prompt may also include metadata about similar emails found in the vector database 120. As such, the operation of LLM classifier 122 may be assisted or augmented by input from the vector database 120. The prompt may include a text representation of a currently classified email. In some implementations, the LLM classifier 122 can classify emails in real-time. The emails may be classified into a certain number of pre-determined categories, such as Business Email Compromise (BEC), phishing, spam, or benign. In other examples, the emails may be classified in a more generalized way, such as a binary classification of threat versus no-threat.

At “Step 7” of FIG. 1B, LLM classifier 122 may produce an output 124 which can include classified emails 138. The classified emails may include email 128, which may now be labeled according to the result from the LLM classifier 122. In some examples, where email 128 is labeled as “malicious,” at Step 8 of FIG. 1B, email 128 may pass to quarantine 126. In other examples, where email 128 is labeled as “benign,” email 128 may exit output 124 and be directed on to computing device 106, for instance. Additionally or alternatively, an email may be labeled as malicious, but may be sent on to computing device 106 and appear in a junk mailbox, for instance.

In some examples, the LLM classifier 122, assisted by the vector database 120, and fed a prioritized stream of email data, may be able to achieve above 90% precision in convicting malicious emails. Such a surprisingly high conviction rate accomplished through prioritized email classification may significantly improve production efficiency for organizations. For instance, a security system for a large organization may be able to successfully convict on the order of approximately 20000 emails per week, which can provide a significant production impact.

Note, the vector database 120 may not necessarily contain a record for every email processed. In some examples, emails passing the threshold at the prioritizer 114 may be directed to the converter 116, then embedder 118, then be stored in the vector database 120. In other examples, not all emails that pass the threshold at the prioritizer 114 are directed to the converter 116 or stored in the vector database 120. For instance, vector database 120 may contain a record for emails that are potentially impactful for future decisions, and/or where intelligence is known about a true label of an email. Thus, some of the emails may follow Steps 3B through 5 of FIG. 1A, while other emails may proceed from the converter 116 to the LLM classifier 122. In some cases, emails may follow both paths. An email may be referred to the vector database 120 after a classification result from LLM classifier 122 identifies the email as malicious, or identifies the email as belonging to an important category of malicious email types, or as a helpful example of a benign email. For instance, the classification result from LLM classifier 122 may indicate that the email belongs to an unusual class of malicious email that does not have enough examples stored in the vector database 120, and therefore refer the email to the vector database 120 as an example. In some examples, a classified email 138 from the output 124 may be directed back to the embedder 118 for processing and inclusion in vector database 120.

In some implementations, the priority score determined by the prioritizer 114 may influence whether an email is sent through to the vector database 120 (e.g., a relatively high priority score), or simply proceeds from the converter 116 to the LLM classifier 122. In some instances, other input may cause a classified email to be added to the vector database 120. For instance, email 128 may be classified as malicious by LLM classifier 122, then may be labeled as malicious and pass through the security system 104 and out to computing device 106. In this instance email 128 may appear in the junk mailbox of a user of computing device 106, or may be viewed by an administrator. The user (or administrator) may provide input indicating that the classification of email 128 as malicious was, in fact, correct. This input may be received by security system 104, which in response may direct email 128 to be added to the vector database 120 as a confirmed example of a malicious email (e.g., high confidence as a malicious example), which may help with future classifications by LLM classifier 122.

Thus, apart from storing emails in vector form, the vector database 120 may include user feedback s on an email (e.g., affirmation of classification, false positive, false negative, etc.). Similarly, the vector database 120 may include other associated information, such as when an email is identified as malicious through an offline or external system. For instance, indicators of compromise (IOCs) or other evidence of a data breach related to the email may have appeared in a trusted threat intelligence feed.

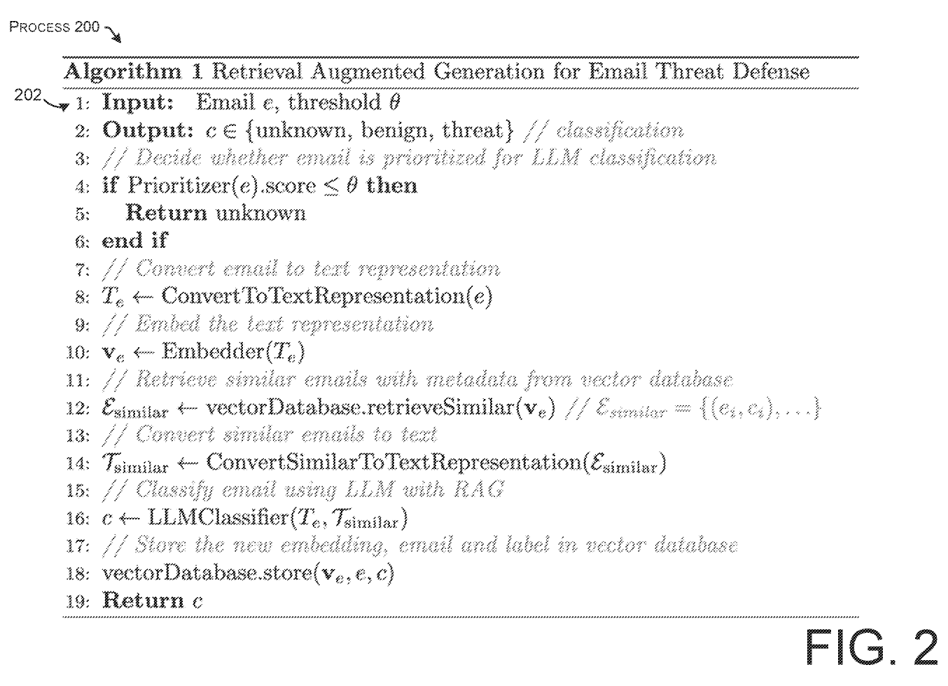

FIG. 2 illustrates an example process 200 in accordance with the present prioritized email security concepts. The example process 200 may be viewed as a prioritized classification algorithm, which may be performed by one or more elements of the security system 104 depicted in FIGS. 1A and 1B. Some aspects of the example elements or steps shown in FIG. 2 may be similar to aspects of the examples described above relative to FIGS. 1A and 1B. Therefore, for sake of brevity, not all elements of FIG. 2 will be described in detail.

As shown in FIG. 2, the example prioritized classification algorithm may include a variety of lines of instructions, indicated generally at 202. For instance, Line 1 of the prioritized classification algorithm indicates that input is received. The input may include receiving an email “e” (e.g., email 128) and receiving a threshold value (e.g., predetermined threshold priority value), for instance. Line 2 may be an input of desired classification labels for the email. Stated another way, Line 2 is indicating a request for classification of the email as one of “unknown,” “benign,” or a “threat,” in this example. Line 3 may be a description of the following step – to decide whether the email is prioritized for LLM classification. Lines 4-6 describe the operation of a prioritizer (e.g., prioritizer 114). For instance, as suggested by Line 4, if a priority score for the email is less than or equal to the threshold value, then the system returns the result as “unknown,” which may indicate that it is unknown whether the email is malicious, but the email is given a low priority for further investigation.

At Line 7 of FIG. 2, the example prioritized classification algorithm may continue with operations that are applied to an email that does pass the prioritization step, in other words, emails that have a priority score higher than the threshold value, in this example. Lines 7 and 8 describe the operation of a converter (e.g., converter 116) that may convert the content of the email to a text representation. Lines 9 and 10 describe the operation of an embedder (e.g., embedder 118) that may convert the text representation of the email to a vector representation, “v.” Lines 11 and 12 describe an interaction with a vector database (e.g., vector database 120), including retrieving emails that are similar to the prioritized input email “e”. As suggested at Line 11, similar emails are identified by having metadata stored in the vector database that is similar to or matches metadata of the input email. At Lines 13 and 14, any identified similar emails may need to be converted to text representations in order to be available as input to the LLM classifier.

Finally, at Lines 15 and 16 of FIG. 2, the example prioritized classification algorithm may include running an LLM classifier (e.g., LLM classifier 122) to generate a label “c” for the input email. The suggestion that the classification is performed with a Retrieval-Augmented Generation (RAG) technique shows that in this example, the quality of the results from the LLM classifier is enhanced by using contextual information (e.g., the metadata from similar emails) to improve the accuracy of classification by the LLM classifier. At Lines 17 and 18, the example prioritized classification algorithm may include storing the embedding “v” of the input email, the email, and the label “c” in the vector database for potential use in future classifications. At Line 19, the example prioritized classification algorithm may return the result, the label “c.”

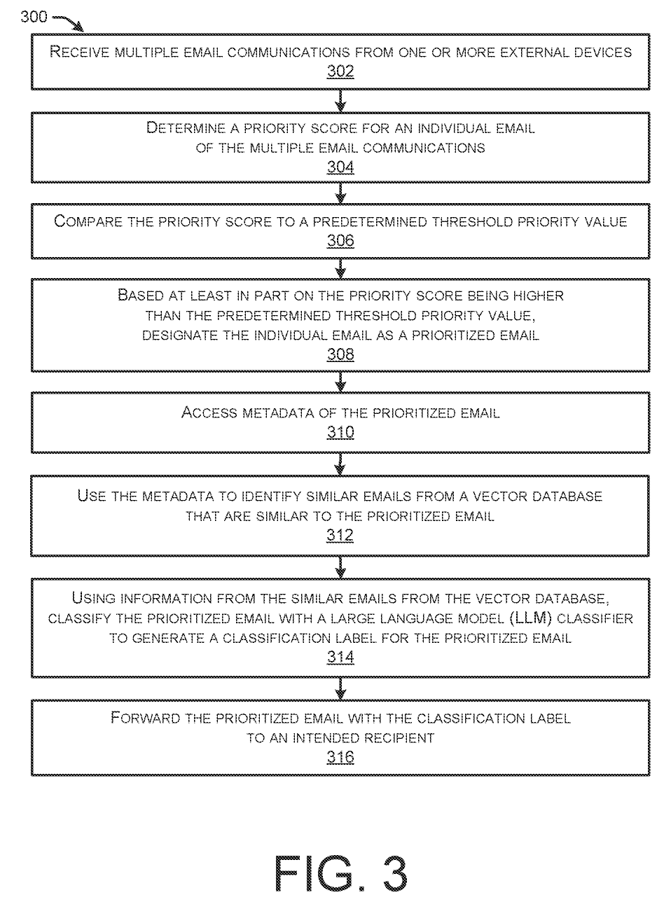

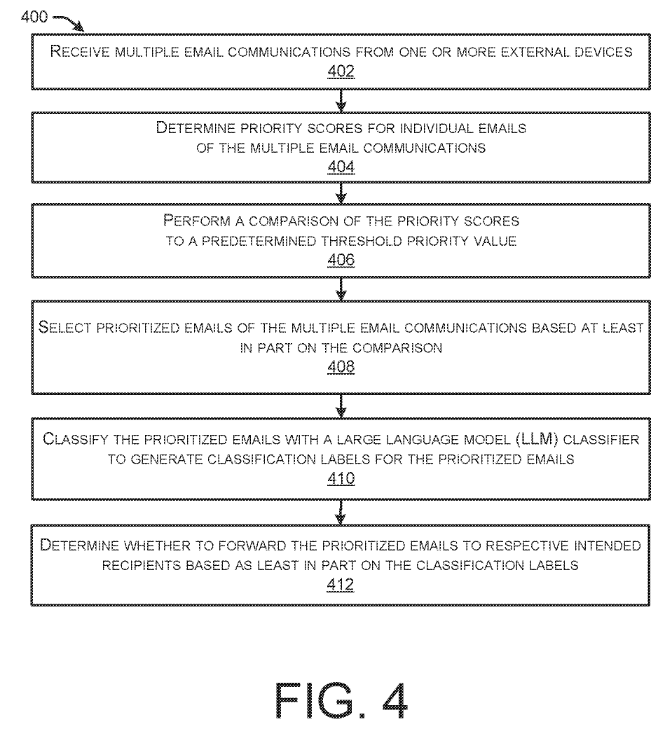

FIGS. 3 and 4 illustrate flow diagrams of example methods 300 and 400 that include functions that may be performed at least partly by security system or service, such as security system 104, described relative to FIGS. 1A-2. The logical operations described herein with respect to FIGS. 3 and 4 may be implemented (1) as a sequence of computer-implemented acts or program modules running on a computing system and/or (2) as interconnected machine logic circuits or circuit modules within the computing system. In some examples, the method(s) 300 and/or 400 may be performed by a system comprising one or more processors and one or more non-transitory computer-readable media storing computer-executable instructions that, when executed by the one or more processors, cause the one or more processors to perform the method(s) 300 or 400.

The implementation of the various devices and/or components described herein is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations might be performed than shown in the FIGS. 3 and 4 and described herein. These operations may also be performed in parallel, or in a different order than those described herein. Some or all of these operations may also be performed by components other than those specifically identified. Although the techniques described in this disclosure is with reference to specific devices and/or services, in other examples, the techniques may be implemented by less devices, more devices, different devices, or any configuration of devices and/or components.

FIG. 3 illustrates a flow diagram of an example method 300 for network devices to prioritized email security techniques. Method 300 may be performed by a security system (e.g., security system 104) communicatively coupled to at least one external user device (e.g., user device 102) and one or more computing devices (e.g., computing device 106), for instance.

At 302, method 300 may include receiving multiple email communications from one or more external devices. The multiple email communications may be received from a variety of sources and devices, such as from other organizations, business colleagues, personal contacts, etc.

At 304, method 300 may include analyzing the multiple email communications for potentially malicious content. In some examples, the analyzing may include determining a priority score for an individual email of the multiple email communications. The priority score may indicate a confidence level of the individual email being malicious. For instance, a higher priority score for a first email may indicate more confidence that the first email is malicious as compared to a lower priority score for a second email. The priority score may be based on content or metadata of the email. For instance, a higher priority score may be assigned to an email that contains a clickable link or an attachment. Analyzing the multiple email communications may also include comparing the priority score to a predetermined threshold priority value. Further, analyzing the multiple email communications may include designating the individual email as a prioritized email where the priority score is higher than the predetermined threshold priority value. In some examples, the predetermined threshold priority value may be selected to purposefully reduce a percentage of the multiple email communications that are prioritized by a significant amount, such as to below 0.1% of all of the incoming multiple email communications. In other examples, the predetermined threshold priority value may be selected to result in a classification balance for input to the LLM classifier. For instance, the predetermined threshold priority value may be selected such that 40-60% of the multiple email communications that are prioritized are ultimately classified as malicious emails.

At 306, method 300 may include accessing metadata of the prioritized email. For example, metadata may include various information associated with the email, such as a header, subject, attachment filename, or URL.

At 308, method 300 may include using the metadata to identify similar emails from a vector database that are similar to the prioritized email. In some cases, method 300 may include embedding the prioritized email as a vector representation in order to more quickly and easily identify similar emails in the vector database.

At 310, method 300 may include classifying the prioritized email with a large language model (LLM) classifier. The LLM classifier may be a generative LLM classifier, for instance. The information from the similar emails from the vector database may be used in the classification. The classification may generate a classification label for the prioritized email. The classification label generated by the LLM classifier may be based on a description of a desired output format that is input to the LLM classifier. For instance, specific classes or labels may be provided to the LLM classifier as a desired result. Requested classes may include business email compromise (BEC), phishing, spam, and benign, in some cases. In other examples, the requested classes may simply be a binary indication of an email being either malicious or benign. The suggestion of particular classification labels is not meant to be limiting, a wide variety of terms is contemplated for labeling emails.

At 312, method 300 may include forwarding the prioritized email with the classification label to an intended recipient. In instances where the classification label for the prioritized email indicates that the prioritized email is malicious, the email may be forwarded to an administrator for review before forwarding to an intended recipient. The email may be sent to a quarantine function of the security system, or to additional processing. An email labeled as malicious may also be forwarded to the intended recipient, but directed to a junk mailbox, or otherwise flagged as potentially malicious for the intended recipient. In some examples, an email may be altered before forwarding to an intended recipient, such as by removing or disabling a clickable link. In some examples, method 300 may also include storing the email and/or a vector representation of the email in association with the classification label in the vector database.

FIG. 4 illustrates a flow diagram of an example method 400 for network devices to prioritized email security techniques. Method 400 may be performed by a security system (e.g., security system 104) communicatively coupled to at least one external user device (e.g., user device 102) and one or more computing devices (e.g., computing device 106), for instance.

At 402, method 400 may include receiving multiple email communications from one or more external devices.

At 404, method 400 may include determining priority scores for individual emails of the multiple email communications. The priority scores may indicate a confidence level that any given individual email may be a malicious email.

At 406, method 400 may include performing a comparison of the priority scores to a predetermined threshold priority value. At 408, method 400 may include selecting prioritized emails of the multiple email communications. The selection may be based on the comparison of the priority scores to the predetermined threshold priority value.

In some examples, method 400 may also include selecting the predetermined threshold priority value to which the priority scores are compared. For instance, output of the LLM classifier may be monitored over time. A success rate of the LLM classifier in identifying actual malicious emails may be determined and monitored over time. In an instance where the success rate is trending downward, the predetermined threshold priority value may be adjusted in an attempt to improve the overall success rate of labeling malicious emails. The predetermined threshold priority value may be lowered to prioritize more emails, with the hope of catching more malicious emails. In other examples, a consumption of resources by the security system could be monitored over time. In some instances, the predetermined threshold priority value could be adjusted with an intent of consuming more or less resources, or with an intent of affecting latency in the system. The predetermined threshold priority value may also be updated to adjust a classification balance for input to the LLM classifier. For instance, the predetermined threshold priority value may be adjusted to achieve a particular percentage of prioritized emails being ultimately classified as malicious. Stated another way, the predetermined threshold priority value may be set to achieve a target rate of 40-60% of the prioritized emails being classified as malicious by the LLM classifier. In this example, if the percentage of emails classified as malicious over a certain period of time rose above a critical percentage, the predetermined threshold priority value could be lowered in order to prioritize more emails for scrutiny by the LLM classifier.

At 410, method 400 may include classifying the prioritized emails with a large language model (LLM) classifier. The LLM classifier may generate classification labels for the prioritized emails. The classification process may include analyzing metadata of the prioritized emails, and may also include accessing additional input for the LLM classifier based on the metadata. For instance, the LLM classifier may seek additional input in the form of additional emails that are found to be similar to the prioritized emails based on having similar metadata.

At 412, method 400 may include determining whether to forward the prioritized emails to respective intended recipients. For instance, whether the emails are forwarded may be based on the classification labels.

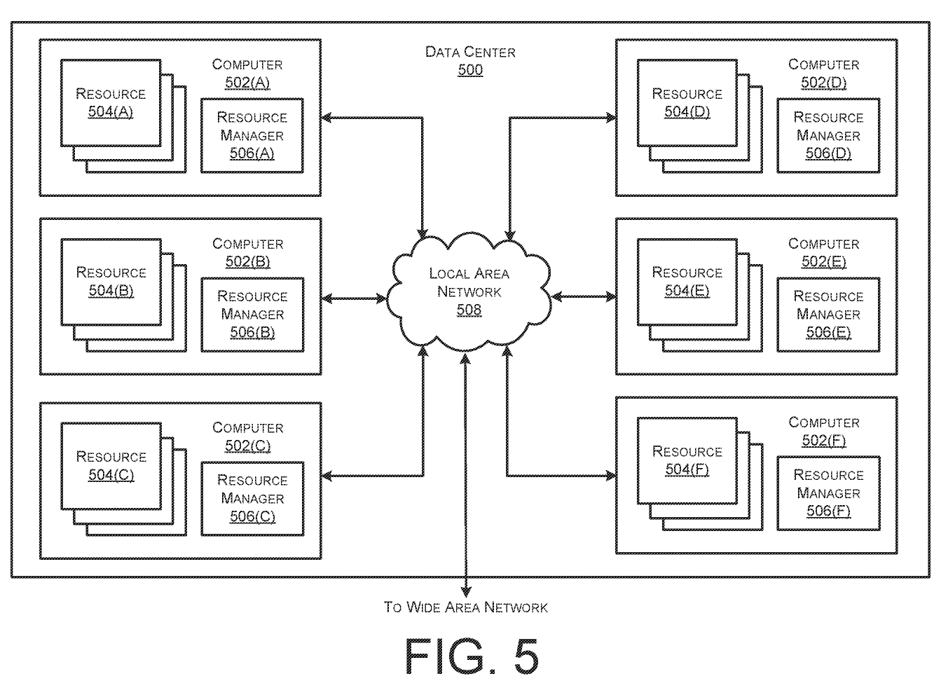

FIG. 5 is a computing system diagram illustrating a configuration for a data center 500 that can be utilized to implement aspects of the technologies disclosed herein. For instance, data center 500 may represent data center 110 described above relative to FIGS. 1A and 1B. The example data center 500 shown in FIG. 5 includes several computers 502A-502F (which might be referred to herein singularly as “a computer 502” or in the plural as “the computers 502”) for providing computing resources. In some examples, the resources and/or computers 502 may include, or correspond to, any type of networked device described herein, such as user device 102, routers, mobile devices, and/or any of computing devices 106. Although, computers 502 may comprise any type of networked device, such as servers, switches, routers, hubs, bridges, gateways, modems, repeaters, access points, hosts, etc.

The computers 502 can be standard tower, rack-mount, or blade server computers configured appropriately for providing computing resources. In some examples, the computers 502 may provide computing resources 504 including data processing resources such as virtual machine (VM) instances or hardware computing systems, database clusters, computing clusters, storage clusters, data storage resources, database resources, networking resources, and others. Some of the computers 502 can also be configured to execute a resource manager 506 capable of instantiating and/or managing the computing resources. In the case of VM instances, for example, the resource manager 506 can be a hypervisor or another type of program configured to enable the execution of multiple VM instances on a single computer 502. Computers 502 in the data center 500 can also be configured to provide network services and other types of services.

In the example data center 500 shown in FIG. 5, an appropriate local area network (LAN) 508 is also utilized to interconnect the computers 502A-502F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 500, between each of the computers 502A-502F in each data center 500, and, potentially, between computing resources in each of the computers 502. It should be appreciated that the configuration of the data center 500 described with reference to FIG. 5 is merely illustrative and that other implementations can be utilized.

In some examples, the computers 502 may each execute one or more application containers and/or virtual machines to perform techniques described herein. For instance, the containers and/or virtual machines may serve as server devices, user devices, and/or routers in the networked computing environment 108.

In some instances, the data center 500 may provide computing resources, like application containers, VM instances, and storage, on a permanent or an as-needed basis. Among other types of functionality, the computing resources provided by a cloud computing network may be utilized to implement the various services and techniques described above. The computing resources 504 provided by the cloud computing network can include various types of computing resources, such as data processing resources like application containers and VM instances, data storage resources, networking resources, data communication resources, network services, and the like.

Each type of computing resource 504 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 504 not mentioned specifically herein.

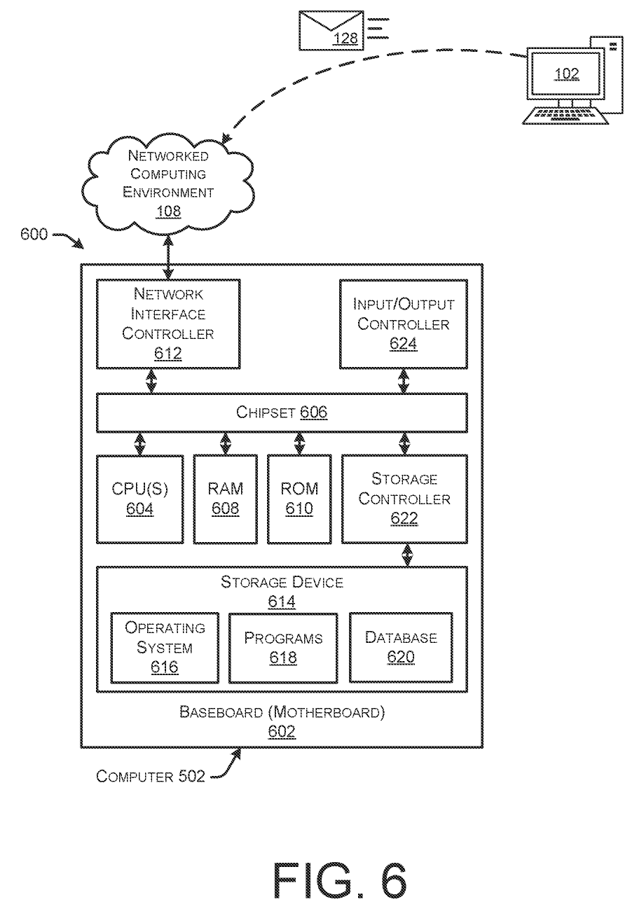

The computing resources 504 provided by a cloud computing network may be enabled in one embodiment by one or more data centers 500 (which might be referred to herein singularly as “a data center 500” or in the plural as “the data centers 500”). The data centers 500 are facilities utilized to house and operate computer systems and associated components. The data centers 500 typically include redundant and backup power, communications, cooling, and security systems. The data centers 500 can also be located in geographically disparate locations. One illustrative embodiment for a data center 500 that can be utilized to implement the technologies disclosed herein will be described below with regards to FIG. 6.

FIG. 6 shows an example computer architecture 600 for a computer 502 capable of executing program components for implementing the functionality described above. The computer architecture 600 shown in FIG. 6 illustrates a conventional server computer, workstation, desktop computer, laptop, tablet, network appliance, e-reader, smartphone, and/or other computing device, and can be utilized to execute any of the software components presented herein. The computer 502 may, in some examples, correspond to a physical device described herein (e.g., user device, computing device, device in a networked computing environment and/or data center, etc.), and may comprise networked devices such as servers, switches, routers, hubs, bridges, gateways, modems, repeaters, access points, etc. For instance, computer 502 may correspond to a device within data center 110.

As shown in FIG. 6, the computer 502 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 502.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 502. The chipset 606 can further provide an interface to a computer-readable storage medium such as a read-only memory (“ROM”) 610 or non-volatile RAM (“NVRAM”) for storing basic routines that help to start up the computer 502 and to transfer information between the various components and devices. The ROM 610 or NVRAM can also store other software components necessary for the operation of the computer 502 in accordance with the configurations described herein.

The computer 502 can operate in a networked environment using logical connections to remote computing devices and computer systems through a network, such as networked computing environment 108, etc. The chipset 606 can include functionality for providing network connectivity through a network interface controller (NIC) 612, such as a gigabit Ethernet adapter. The NIC 612 is capable of connecting the computer 502 to other computing devices over the networked computing environment 108. For instance, in the example shown in FIG. 6, NIC 612 may help facilitate transfer of data, packets, and/or communications (indicated by email 128 in FIG. 6) over the networked computing environment 108 with computer 502. It should be appreciated that multiple NICs 612 can be present in the computer 502, connecting the computer to other types of networks and remote computer systems.

The computer 502 can be connected to a storage device 614 that provides non-volatile storage for the computer. The storage device 614 can store an operating system 616, programs 618, a database 620 (e.g., vector database 120), and/or other data. The storage device 614 can be connected to the computer 502 through a storage controller 622 connected to the chipset 606, for example. The storage device 614 can consist of one or more physical storage units. The storage controller 622 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 502 can store data on the storage device 614 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 614 is characterized as primary or secondary storage, and the like.

For example, the computer 502 can store information to the storage device 614 by issuing instructions through the storage controller 622 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 502 can further read information from the storage device 614 by detecting the physical states or characteristics of one or more particular locations within the physical storage units.

In addition to the mass storage device 614 described above, the computer 502 can have access to other computer-readable storage media to store and retrieve information, such as policies, program modules, data structures, and/or other data. It should be appreciated by those skilled in the art that computer-readable storage media is any available media that provides for the non-transitory storage of data and that can be accessed by the computer 502. In some examples, the operations performed by the networked computing environment 108, and/or any components included therein, may be supported by one or more devices similar to computer 502. Stated otherwise, some or all of the operations performed by the networked computing environment 108, and or any components included therein, may be performed by one or more computer devices 502 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, ternary content addressable memory (TCAM), and/or other optical storage, magnetic cassettes, magnetic tape, magnetic disk storage or other magnetic storage devices, or any other medium that can be used to store the desired information in a non-transitory fashion.

As mentioned briefly above, the storage device 614 can store an operating system 616 utilized to control the operation of the computer 502. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 614 can store other system or application programs and data utilized by the computer 502.

In one embodiment, the storage device 614 or other computer-readable storage media is encoded with computer-executable instructions which, when loaded into the computer 502, transform the computer from a general-purpose computing system into a special-purpose computer capable of implementing the embodiments described herein. These computer-executable instructions transform the computer 502 by specifying how the CPUs 604 transition between states, as described above. According to one embodiment, the computer 502 has access to computer-readable storage media storing computer-executable instructions which, when executed by the computer 502, perform the various processes described above with regards to FIGS. 1A-4. The computer 502 can also include computer-readable storage media having instructions stored thereupon for performing any of the other computer-implemented operations described herein.

The computer 502 can also include one or more input/output controllers 624 for receiving and processing input from a number of input devices, such as a keyboard, a mouse, a touchpad, a touch screen, an electronic stylus, or other type of input device. Similarly, an input/output controller 624 can provide output to a display, such as a computer monitor, a flat-panel display, a digital projector, a printer, or other type of output device. It will be appreciated that the computer 502 might not include all of the components shown in FIG. 6, can include other components that are not explicitly shown in FIG. 6, or might utilize an architecture completely different than that shown in FIG. 6.

As described herein, the computer 502 may comprise one or more devices, such as a user device 102, computing device 106, any device of networked computing environment 108 and/or data center(s) 110, and/or other devices. The computer 502 may include one or more hardware processors 604 (processors) configured to execute one or more stored instructions. The processor(s) 604 may comprise one or more cores. Further, the computer 502 may include one or more network interfaces configured to provide communications between the computer 502 and other devices, such as the communications described herein as being performed by a user device 102, computing device 106, any device of networked computing environment 108 and/or data center(s) 110, and/or other devices. In some examples, the communications may include email, attachment, messages data, packet, instructions, policy, and/or other information transfer, for instance. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 618 may comprise any type of programs or processes to perform the techniques described in this disclosure in accordance with password linkage techniques. For instance, the programs 618 may cause the computer 502 to perform techniques for communicating with other devices using any type of protocol or standard usable for determining connectivity. Additionally, the programs 618 may comprise instructions that cause the computer 502 to perform the specific techniques for prioritized email security.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A computer-implemented method comprising:
receiving multiple email communications from one or more external devices;
analyzing the multiple email communications for potentially malicious content, the analyzing comprising:
determining a priority score for an individual email of the multiple email communications, the priority score indicating a confidence level of the individual email being malicious,
comparing the priority score to a predetermined threshold priority value, and
based at least in part on the priority score being higher than the predetermined threshold priority value, designating the individual email as a prioritized email;
accessing metadata of the prioritized email;
using the metadata to identify similar emails from a vector database that are similar to the prioritized email;
using information from the similar emails from the vector database, classifying the prioritized email with a large language model (LLM) classifier to generate a classification label for the prioritized email; and
forwarding the prioritized email with the classification label to an intended recipient.

2. The computer-implemented method of claim 1, further comprising:
embedding the prioritized email as a vector representation; and
storing the vector representation of the prioritized email in association with the classification label in the vector database.

3. The computer-implemented method of claim 1, wherein the LLM classifier is a generative LLM classifier.

4. The computer-implemented method of claim 1, wherein the predetermined threshold priority value is selected to reduce a percentage of the multiple email communications that are prioritized to below 0.1% of the multiple email communications.

5. The computer-implemented method of claim 1, wherein the predetermined threshold priority value is selected to result in a classification balance for input to the LLM classifier such that 40-60% of the multiple email communications that are prioritized are classified as malicious emails.

6. The computer-implemented method of claim 1, wherein the classification label generated by the LLM classifier is based at least in part on a description of a desired output format that is input to the LLM classifier.

7. The computer-implemented method of claim 6, wherein the description of a desired output format that is input to the LLM classifier comprises at least one of:
business email compromise (BEC);
phishing;
spam; and
benign.

8. The computer-implemented method of claim 1, wherein the classification label for the prioritized email indicates that the prioritized email is malicious, the computer-implemented method further comprising:
forwarding the prioritized email to an administrator for review before forwarding the prioritized email to an intended recipient.

9. A security system comprising:
one or more processors; and
one or more non-transitory computer-readable media storing computer-executable instructions that, when executed by the one or more processors, cause the one or more processors to:
receive multiple email communications from one or more external devices;
analyze the multiple email communications for potentially malicious content, the analyzing comprising:
determining a priority score for an individual email of the multiple email communications, the priority score indicating a confidence level of the individual email being malicious,
comparing the priority score to a predetermined threshold priority value, and
based at least in part on the priority score being higher than the predetermined threshold priority value, designating the individual email as a prioritized email;
access metadata of the prioritized email;
use the metadata to identify similar emails from a vector database that are similar to the prioritized email;
using information from the similar emails from the vector database, classify the prioritized email with a large language model (LLM) classifier to generate a classification label for the prioritized email; and
forward the prioritized email with the classification label to an intended recipient.

10. The security system of claim 9, wherein the computer-executable instructions further cause the one or more processors to:
embed the prioritized email as a vector representation; and
store the vector representation of the prioritized email in association with the classification label in the vector database.

11. The security system of claim 9, wherein the LLM classifier is a generative LLM classifier.

12. The security system of claim 9, wherein the predetermined threshold priority value is selected to reduce a percentage of the multiple email communications that are prioritized to below 0.1% of the multiple email communications.

13. The security system of claim 9, wherein the predetermined threshold priority value is selected to result in a classification balance for input to the LLM classifier such that 40-60% of the multiple email communications that are prioritized are classified as malicious emails.

14. The security system of claim 9, wherein the classification label generated by the LLM classifier is based at least in part on a description of a desired output format that is input to the LLM classifier.

15. The security system of claim 14, wherein the description of a desired output format that is input to the LLM classifier comprises at least one of:
business email compromise (BEC);
phishing;
spam; and
benign.

16. The security system of claim 9, wherein the classification label for the prioritized email indicates that the prioritized email is malicious, and wherein the computer-executable instructions further cause the one or more processors to:
forward the prioritized email to a quarantine before forwarding the prioritized email to an intended recipient.

17. A method comprising:
receiving multiple email communications from one or more external devices;
determine priority scores for individual emails of the multiple email communications, the priority scores indicating a confidence level that any given individual email may be a malicious email;
performing a comparison of the priority scores to a predetermined threshold priority value;
selecting prioritized emails of the multiple email communications based at least in part on the comparison;
classifying the prioritized emails with a large language model (LLM) classifier to generate classification labels for the prioritized emails; and
determining whether to forward the prioritized emails to respective intended recipients based as least in part on the classification labels.

18. The method of claim 17, further comprising:
analyzing metadata of the prioritized emails; and
accessing additional input for the LLM classifier based at least in part on the metadata,
wherein the additional input is used to classify the prioritized emails.

19. The method of claim 17, further comprising:
selecting the predetermined threshold priority value;
monitoring output of the LLM classifier; and
based at least in part on the monitoring the output, updating the predetermined threshold priority value to adjust a classification balance for input to the LLM classifier.

20. The method of claim 19, wherein the predetermined threshold priority value is adjusted to achieve a target rate of 40-60% of the prioritized emails classified as malicious emails by the LLM classifier.
